(19) United States
(12) Patent Application Publication
(10) Pub. No.: US 2011/0299715 A1
(43) Pub. Date: Dec. 8, 2011

(54) Novelty Garment and Related Method of Use

(76) Inventor: Stewart KAISER, Boca Raton, FL (US)

(21) Appl. No.: 13/085,063

(22) Filed: Apr. 12, 2011

Related U.S. Application Data
(60) Provisional application No. 61/352,076, filed on Jun. 7, 2010.

(51) Int. Cl. H04R 1/02; A41B 1/00; A41D 1/00

(52) U.S. Cl. 381/388; 2/69

(57) ABSTRACT

The invention is directed to a novelty garment, formed as a clothing article, which can broadcast a sound recording. The clothing article may be a t-shirt, tank top, or related garment having an outside and an inside. An annular sleeve is attached to the inside of the clothing article and encases a circuit board having a processor, a memory device, a power source, and a speaker. Placed around the circuit board is a waterproof bladder having a sufficient size and dimension to fit within the annular sleeve. The processor is capable of receiving signals from one or more pressure sensors, an RFID Tag or a WIFI receiver to upload a sound recording stored within the memory device for performance by the speaker.

### CROSS REFERENCE TO RELATED APPLICATIONS

This application claims the benefit of U.S. Provisional Application Ser. No. 61/352,076 the disclosure of which is hereby incorporated by reference and herein in its entirety all commonly owned.

### FIELD OF THE INVENTION

This invention is directed toward a fabric garment that allows audio recordings to be played within the garment. More specifically, the invention relates to a circuit housed within a waterproof bladder, which in turn fits within a garment.

### BACKGROUND OF THE INVENTION

Novelty garments represent a growing and viable component of the clothing industry. More specifically, consumers enjoy purchasing various t-shirts (and related items) that feature the logos, slogans and other indicia that either define their lifestyles or alternatively their current situations in life. As for lifestyle, this may include a particular collegiate or professional sporting team that the consumer supports.

A growing component of these novelty garments relates to event specific clothing. For example, a consumer may purchase a t-shirt (or other clothing item) that relates to a particular city that they are visiting. Alternatively, the consumer may want to purchase a clothing item at a vacation destination such as a resort, theme park or spectacle (i.e., a Las Vegas show, a Broadway musical, or a related musical or theatrical production). For example, a visitor to a theme park may want to don a t-shirt that relates to a specific thrill ride they experienced in order to add to the enjoyment and participation of their vacation.

Often such novelty clothing will not only include graphics in the form of silkscreen printing, but also other indicia. Traditionally, this indicia has included various LED lights connected to an internal battery supply which may illuminate and light up upon pressing a switch. In addition, more recent advances have included the use of pre-recorded audio recordings. Thus, upon pressing a button a sound recording may emanate from the garment that typically matches the theme of the t-shirt (or related clothing item). These novelty garments are especially popular with young adults and children, in addition to adults traveling and participating with families.

There exist multiple drawbacks in the current design and functionality of typical garments that allow for the playing of pre-recorded sound recordings. One example of a rudimentary known garment is found in U.S. patent application Ser. No. 10/653,431 filed on Sep. 2, 2003 entitled “Children's dress up toy capable of outputting a sound” to Nasstrom. The Nasstrom reference teaches a toy garment containing a sound garment device having one or more actuator switches and an outer housing. However, the sound generating device is bulky and heavy requiring it to be worn proximate the hips. Moreover, the device is not waterproof such that it cannot be washed within the garment but instead must be removed.

Accordingly, there is a need in the art for a durable and integrated novelty garment that allows for performance of an audio recording. Such novelty garment should preferably include a waterproof audio component that need not be removed prior to washing. This is especially needed in light of the fact that such novelty garments absorb water during outdoor events, like visiting a resort, beach or water park. Moreover, the electronic components of such item may be easily overlooked when laundering the item along with other articles of clothing.

### SUMMARY OF THE INVENTION

The instant invention solves many of the limitations found in current novelty garments that allow for performance of an audio recording. Moreover, the invention allows for an integrated sound generating assembly within a clothing article that is waterproof and durable. Accordingly, the invention allows use of the novelty garment in outdoor events such as visiting a beach or resort, or alternatively enjoying a water park. Moreover, the device can be laundered.

One embodiment of the invention may be described as a novelty garment comprising a clothing article having an outside and an inside. Such article of clothing is selected from a group consisting of a t-shirt, button down shirt, tank top, halter-top, and a swimsuit cover-up. An annular sleeve may be attached to the inside of the clothing article sleeve having a first end, a corresponding second end, a right side and a corresponding left side. Positioned within the annular sleeve is a circuit board having a processor, a memory device, a power source, and a speaker. Optionally, the circuit board may also include an amplifier.

A waterproof bladder of sufficient size and dimension to maintain the circuit board may be employed to ensure the clothing article is washable and capable of use in a variety of outdoor activities. The waterproof bladder also has a sufficient size and dimension to fit within the annular sleeve. Preferably, the first end of the annular sleeve includes an opening capable of removing and inserting of the waterproof bladder containing the circuit board. Such opening may include a hook and loop fastener.

The circuit board may have a variety of triggering mechanisms to tell the processor to play a sound recording. This may include a magnetic strip, in the form of an RFID Tag capable of sending a signal to the processor when the magnetic strip passes through a detector. Another functionality may include a WIFI receiver capable of receiving instructions from a network and reporting these instructions to the processor.

### BRIEF DESCRIPTION OF THE DRAWINGS

For a fuller understanding of the invention, reference is made to the following detailed description, taken in connection with the accompanying drawings illustrating various embodiments of the present invention, in which:

FIG. 1 illustrates an outside view of a novelty garment including ornamentation;

FIG. 2 illustrates the inside of a novelty garment having an annular sleeve capable of maintaining a circuit board;

FIG. 3 is a close up view of the annular sleeve;

FIG. 4 is a cut away view of the annular sleeve of the novelty garment;

FIG. 5 is a top view of the circuit board; and

FIG. 6 is a flow chart identifying a method of use for the novelty garment.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Housing for the Novelty Garment

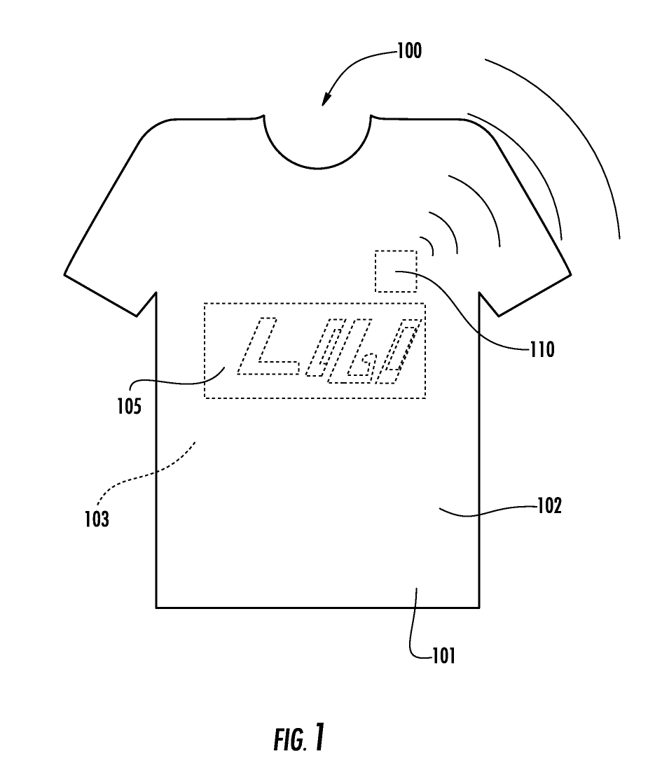

FIGS. 1 through 5 show, by way of example, the salient components of one preferred novelty garment 100 taught by the present invention. These figures specifically include illustration of the housing for the novelty garment 100. First turning to FIG. 1, the novelty garment 100 including an overall clothing article 101. As shown, FIG. 1 illustrates the exterior 102 of a clothing article 101. Such clothing article 101 can be any form of t-shirt, tank top, halter top, blouse, button-down, oxford, swimsuit cover-up or similar item. Optionally, ornamentation 105 in the form of a logo, slogan or other indicia may be placed about the clothing article 101. Such ornamentation 105 can be placed about the clothing article 101 via silkscreen printing, embroidery or similar means known to those skilled in the art.

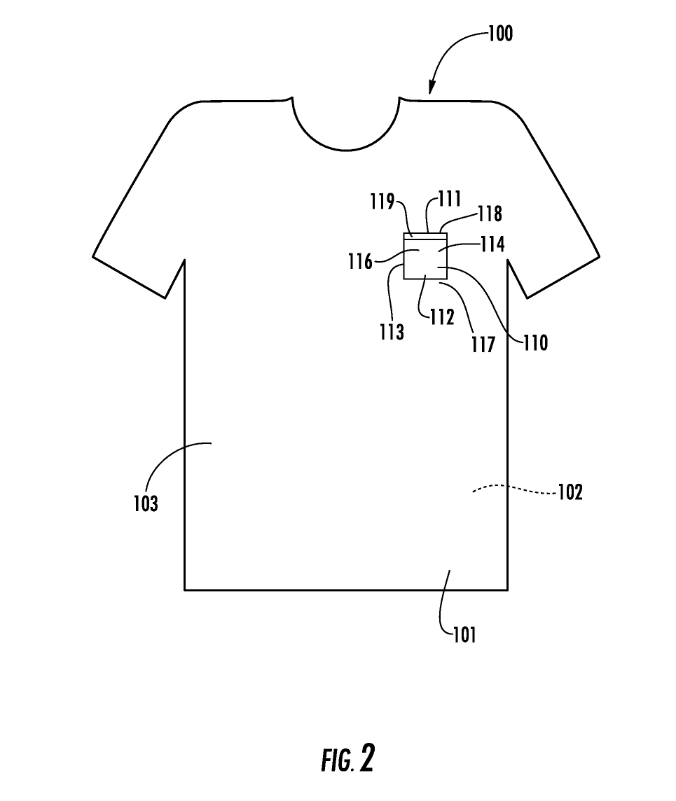

While FIG. 1 illustrates the outside 102 of the clothing article 101, FIG. 2 in contrast shows the interior 103 of the novelty garment 100. As shown in FIG. 2, the interior 103 includes an annular sleeve 110. Due to the lightweight components and construction of the novelty garment 100, the annular sleeve 110 can be placed at any point about the torso of the wearer.

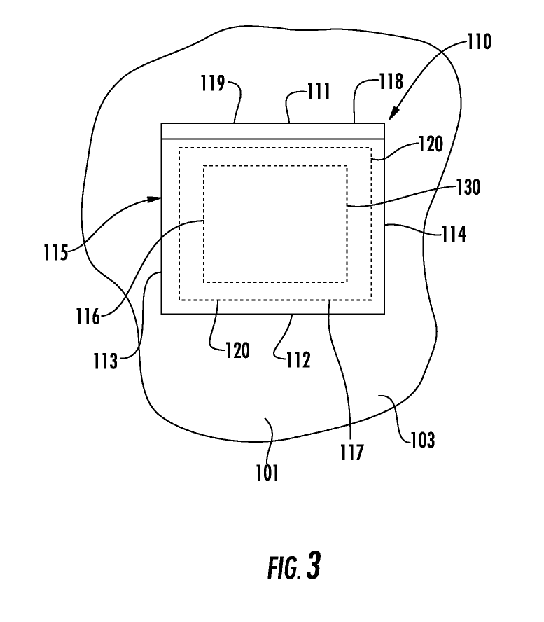

FIG. 3 illustrates, by way of example, the construction of the annular sleeve 110. As shown, the annular sleeve 110 includes first end 111 and a second end 112, as well as a left side 113 and a right side 114. Moreover, there are essentially two panels 115 which form the annular sleeve 110. The first panel 116 is preferably a portion of the interior 103 of the clothing article 101. The second panel 117 is preferably in parallel with the interior 103, and may be made out of the same or similar fabric as to clothing article 101.

Optionally, the annular sleeve 110 may include an opening 118 to allow access to the components of the novelty shirt 100. Such opening 118 is preferably at the first end 111 (or alternatively as the second end 112) of the annular sleeve 110. The opening 118 may be secured and sealed through use of a fastener 119, which may be a hook-and-loop fastener, zipper, or related system.

### The Circuit Board and Bladder

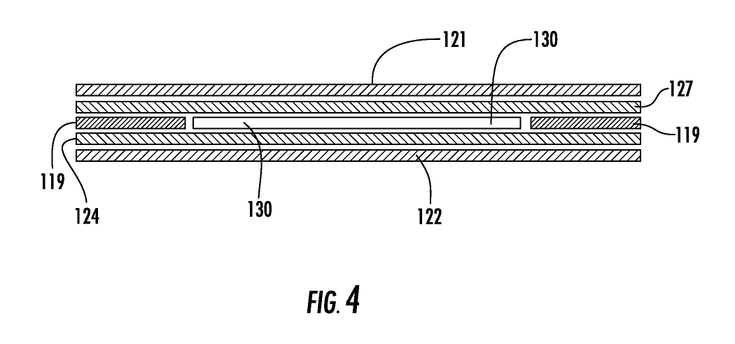

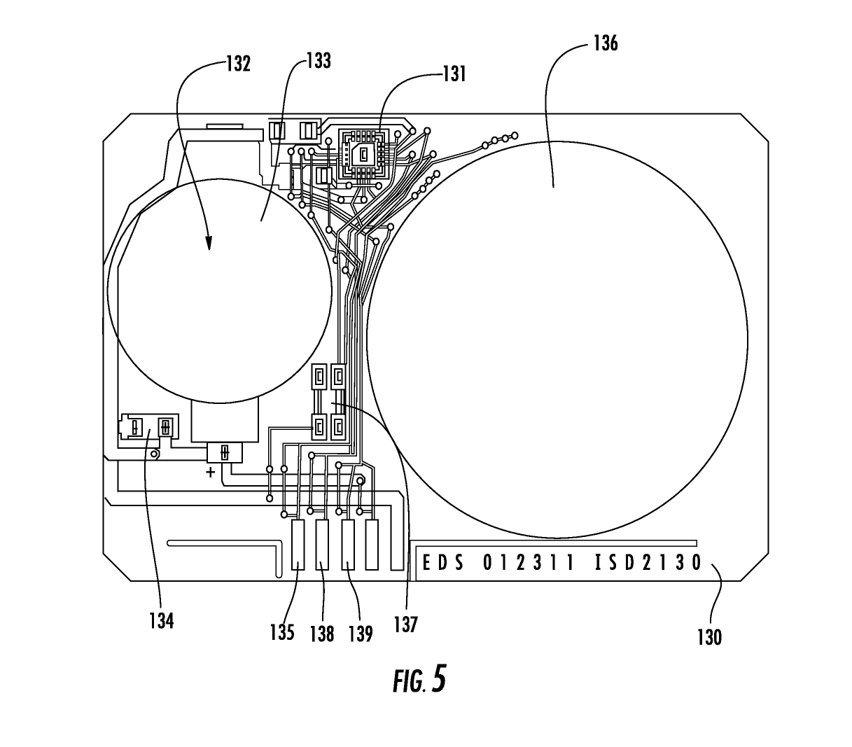

While FIGS. 1 through 3 illustrate the housing of novelty garment 100, FIGS. 4 and 5 illustrate a circuit board 130 and waterproof bladder 120. First turning to FIG. 4, the water proof bladder 120 may be placed around the circuit board 130. As shown, the waterproof bladder 120 may include a first sheet 121 and corresponding second sheet 122. The sheets 121 and 122 are essentially parallel to each other and surround the circuit board 130. Moreover, the sheets 121 and 122 are preferably signed (or the like) to form a waterproof seal to prevent moisture from contacting the circuit board 130.

The sheets 121 and 122 of the waterproof barrier 120 are of a sufficient size and dimension to be housed and maintained within both panels 116 and 117 of the annular sleeve 110. Optionally positioned between the first sheet 121 and the first panel 116 is a first foam layer 123. Conversely, a second foam layer 124 may be placed between the second sheet 122 and the second panel 117. Both foam layers 123 and 124 are sufficient to provide additional padding such that the user does not feel the circuit board 130 while conversely not affecting the ability to broadcast sound recordings. Alternatively, both foam layers 123 and 124 may be placed within the waterproof bladder 120 to surround the circuit board 130.

FIG. 5 illustrates, by way of example the circuit board 130. As shown, the circuit board 130 houses and maintains the electronic components necessary to perform and reproduce sound recordings by the novelty garment 100. Such circuit board 130 includes a processor 131, a power supply 132 (which can take the form of a battery 133), a memory device 134, a pressure switch 135, and a flat speaker 136. The memory device 134 is preferably a flash based device capable of storing one or more sound recordings in a digital format. The processor 131 is powered by the battery 133 to read the memory device 134 and perform a sound recording through the flat speaker 136. Optionally, an amplifier 137 may be used with the flat speaker 136 to aid in broadcasting the sound recording.

The invention contemplates a number of devices to engage the processor 131 for the flat speaker 136 to provide a sound recording for the novelty garment 100. This includes the pressure switch 135. Through the user either physically pressing the pressure switch 135 (or alternatively some third-party force engaging the clothing article 101) a signal is sent to the processor 131 to broadcast.

A second option to trigger the processor 131 is use of an RFID tag 138 (or similar tag device). Such RFID tag 138 is specifically directed toward using the novelty garment 100 at an event or a theme park. Through walking through a scanning device, the RFID tag 138 electrical properties are such that they will provide a signal to the processor 131 when passing certain portions of a theme park ride (or portion of the theme park) such that cause a sound recording to be performed. More specifically, a series of sound recordings may be stored on the memory device 134. By passing the novelty garment 100 through different strength electrical fields, magnetic by way of example, the RFID tag 138 sends different signals to the processor 131 that in turn provide different pre-specified sound recordings.

Yet a third option to engage the processor 131 to perform a sound recording is through a WIFI receiver 139. Based upon receiving a signal, the WIFI receiver 139 may instruct the processor 131 to perform a specified sound recording. This again would be advantageous at a theme park or other related event. Throughout a period of time (such as at a performance or on a theme park ride), a WIFI signal could be directed to the WIFI receiver 139 to play a specific series of sound recordings stored on the memory device 134. For example, during a performance every user wearing a novelty shirt 100 could perform a specific number of sound recordings to complement the entertainment.

### Method of Use

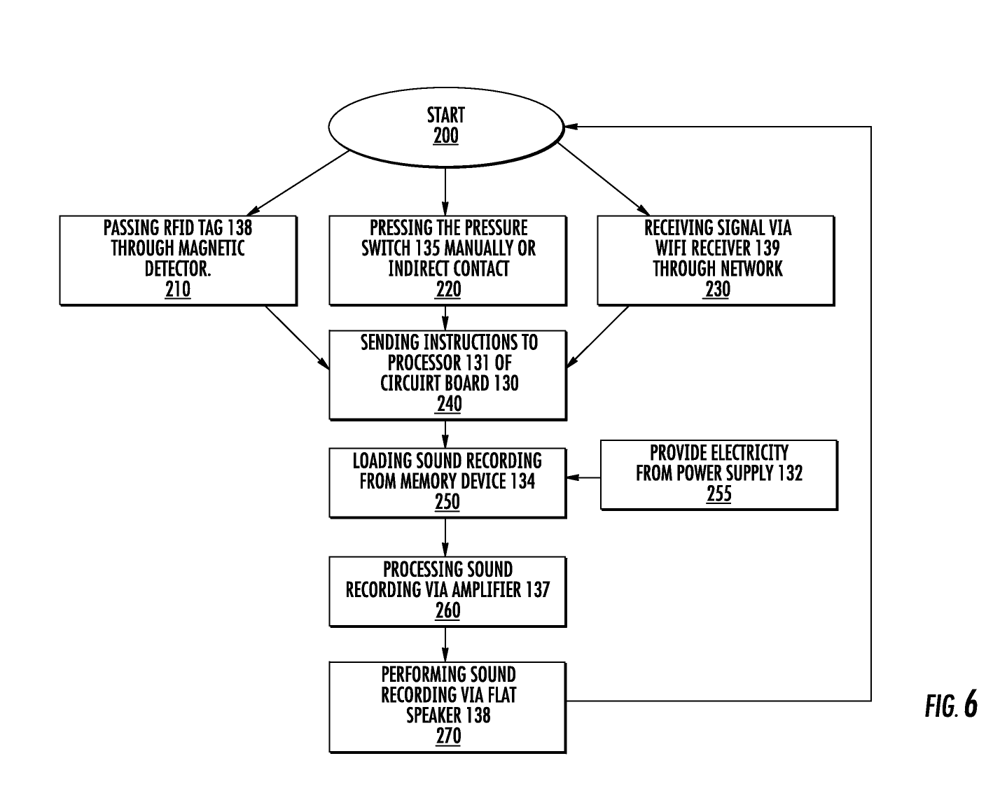

The invention is also directed toward a method of providing sound broadcasts through the novelty garment 100. FIG. 6 illustrates, by way of example, one method for using the novelty garment 100. The method starts (at 200) with determining what form of signal receiver is available (either an RFID Tag 138, a pressure switch 135 or a WIFI receiver 139). If the system detects an RFID Tag 138, it determines if the RFID Tag 138 has passed (at 210) through a magnetic detector (or similar system). Alternatively, the user may manually press (at 220) the pressure switch 210 positioned within the annular sleeve 110. Lastly, the system detects if the circuit board 130 is receiving (at 230) instructions from a network via a WIFI receiver 139.

The method next calls for sending (at 240) these instructions (from any of the above mentioned receiving devices) to a processor 131 of the circuit board 130. This next triggers the sending (at 250) of one or more sound recordings stored in the memory device 134. This may also call for receipt of electricity to power (at 255) both the processor 131 and the memory device 134. The sound recordings are then processed (at 260) through an amplifier 137. Such audio files then go from the amplifier 147 to the flat speaker 138 where they are performed (at 270). The system then loops back and the process begins anew.

I claim:

1. A garment capable of broadcasting a sound recording, the garment comprising:
a clothing article having an outside and an inside;
an annular sleeve attached to the inside of the clothing article, the annular sleeve having a first end, a corresponding second end, a right side and a corresponding left side;
a circuit board encased by the annular sleeve, the circuit board having a processor, a memory device, a power source, and a speaker; and
a waterproof bladder of a sufficient size and dimension to enclose the circuit board therein, the waterproof bladder of sufficient size and dimension to fit within the annular sleeve.

2. The garment of claim 1, further comprising a magnetic strip capable of sending a signal to the processor when the magnetic strip passes through a detector.

3. The garment of claim 2, wherein the magnetic strip is an RFID tag.

4. The garment of claim 1, further comprising a WIFI receiver capable of receiving instructions from a network and reporting these instructions to the processor.

5. The garment of claim 1, wherein the speaker includes an amplifier.

6. The garment of claim 1, wherein the first end of the annular sleeve includes an opening capable of removing and inserting of the waterproof bladder containing the circuit board.

7. The garment of claim 6, wherein the opening of the annular sleeve includes a hook-and-loop fastener.

8. The garment of claim 1, wherein the clothing article is selected from a group consisting of a t-shirt, button down shirt, tank top, halter-top, and a swimsuit cover-up.

9. A garment capable of broadcasting a sound recording, the garment comprising:
a clothing article having an outside and an inside;
an annular sleeve attached to the inside of the clothing article;
a circuit board having a processor, a memory device, a power source, a speaker and a WIFI receiver capable of receiving instructions from a network and reporting these instructions to the processor; and
a waterproof bladder encasing the circuit board, the waterproof bladder carried within the annular sleeve.

10. The garment of claim 9, further comprising a magnetic strip capable of sending a signal to the processor when the magnetic strip passes through a detector.

11. The garment of claim 10, wherein the magnetic strip is an RFID tag.

12. The garment of claim 9, further comprising a pressure switch.

13. The garment of claim 9, wherein the speaker includes an amplifier.

14. The garment of claim 9, wherein a first end of the annular sleeve includes an opening capable of removing and inserting of the waterproof bladder containing the circuit board.

15. The garment of claim 14, wherein the opening of the annular sleeve includes a hook-and-loop fastener.

16. The garment of claim 9, wherein the clothing article is selected from a group consisting of a t-shirt, button down shirt, tank top, halter-top, and a swimsuit cover-up.

17. A method of broadcasting sound recordings from a garment, the method comprising the steps of:
receiving data for a network through a WIFI receiver connected to a processor, both the WIFI receiver and processor being maintained within a circuit board contained within a waterproof bladder, the circuit board also having a memory device, a power source and a speaker, the waterproof bladder in turn maintained within an annular sleeve affixed to a clothing article;
rendering instructions from the WIFI receiver to the processor regarding a sound recording, maintained on the memory device, to be performed;
loading the sound recording from the memory device;
performing the sound recording through the speaker, the speaker being capable of transmitting sound from the circuit board, through the waterproof bladder to be emanated out of the annular sleeve of the clothing article.

18. The method of claim 17, further comprising the step of processing the sound recording received from the processor and transmitting it to the speaker.

19. The method of claim 17, further comprising the step of providing electrical power through a power source to enable the processor, memory device, and speaker.

20. The method of claim 17, further comprising the step of passing an RFID tag through a magnetic detector and sending a signal to the processor.
